(19) United States
(12) Patent Application Publication
(10) Pub. No.: US 2023/0232852 A1
(43) Pub. Date: Jul. 27, 2023

(54) METHOD FOR LIQUID FERMENTATION OF BLACK TEA JUICE BY USING AGED GREEN TEA

(71) Applicant: Chinese Academy of Agricultural Sciences, Tea Research Institute, Zhejiang (CN)

(72) Inventors: Yong-Quan Xu, Zhejiang (CN); Jun-Feng Yin, Zhejiang (CN); Shuang Liang, Zhejiang (CN)

(73) Assignee: Chinese Academy of Agricultural Sciences, Tea Research Institute, Zhejiang (CN)

(21) Appl. No.: 17/888,504

(22) Filed: Aug. 16, 2022

(30) Foreign Application Priority Data
Jan. 24, 2022 (CN) 202210077589.X

(51) Int. Cl. A23F 3/10; A23F 3/16; A23F 3/18

(52) U.S. Cl. CPC A23F 3/10; A23F 3/166; A23F 3/18

(57) ABSTRACT

The present disclosure discloses a method for liquid fermentation of black tea juice by using aged green tea and belongs to the technical field of tea leaf processing. The method comprises the following process steps: mixing aged green tea with hot water for a water bath-assisted extraction; adding a tannase into a crude catechin extract for a water bath-assisted enzymolysis; freeze-withering fresh tea leaves; homogenizing the freeze-withered leaves; pouring a homogenate into a primarily enzymolyzed crude catechin extract, adding a β-glucosidase for secondary enzymolysis and performing fermentation; and treating a fermentation broth by microwave, and performing filtration and cooling to a room temperature.

### CROSS-REFERENCE TO RELATED APPLICATION

This application claims the priority benefit of China application serial no. 202210077589.X, filed on Jan. 24, 2022. The entirety of the above-mentioned patent application is hereby incorporated by reference herein and made a part of this specification.

### FIELD OF TECHNOLOGY

The present disclosure belongs to the technical field of tea leaf processing and particularly relates to a method for liquid fermentation of black tea juice by using aged green tea.

### BACKGROUND

The area of tea gardens and the yield of tea leaves in China rapidly increase year by year. In 2020, the area of tea gardens exceeds 47.47 million mu and the yield of tea leaves is 2.98 million tons. China is the largest tea leaf planting and production country in the world. Green tea is the leading tea in China all the time and accounts for about 60% of the yield of tea leaves. However, a problem of unsalable low-grade green tea is increasingly outstanding. A large amount of green tea inventory is accumulated in many enterprises. About 25 million tons of green tea is accumulated only in 2019. In order to reduce economic loss and promote healthy development of the tea market, how to treat the inventory is one of the problems to be urgently solved in the tea industry.

The green tea is unfermented and greatly reserves original natural aroma components. More than 300 green tea aroma components are identified. These components form unique faint scent and freshness of the green tea according to certain content and proportion. During long-time storage, main biochemical components of flavonoids such as catechin, chlorophyll and anthocyanin, amino acids and lipids are subjected to oxidation and condensation under the action of air, moisture, light, heat and the like, and therefore original color, aroma and taste are changed, and typical quality and flavor characteristics are lost. With increase of storage time, the unique faint scent of new tea gradually dissipates, stale odor increases, and therefore the quality of the tea leaves is reduced, and huge economic loss is caused.

The tea leaves can be divided into six kinds. “Enzyme deactivation” of the green tea is changed into “rolling” and “fermentation” in one step. The enzymes of the fresh leaves are used instead of inactivation by heating, such that the black tea with completely different flavor characteristics can be obtained. Specifically, the rolled fresh leaves are damaged, an endogenous polyphenol oxidase and a peroxidase react with oxygen to oxidize catechin into o-quinone which is further condensed into theaflavin, thearubigin, theabrownin and the like, and the tea leaves are dried to obtain black tea. Therefore, the green tea containing the catechin can be mixed with the fresh leaves to prepare the black tea, which is also a biochemical basis of the black tea prepared by the green tea.

The black tea is popular in the foreign market. In addition to China, India, Sri Lanka, and Kenya mainly produce the black tea, and Europe and the United States mainly consume the black tea. Since the 60's of the 20th century, many tea leaf manufacturers have attempted to produce black tea beverages or instant black tea powder directly from fresh tea leaves as a raw material. Fresh tea leaves are used as a raw material and directly processed into tea beverages through liquid fermentation, such that a traditional production process of tea beverages is simplified, energy is saved, and the tea beverages contain more functional active substances and unique sensory characteristics, namely red and bright color, fresh and mellow taste, sweet and fragrant aroma and slight green grass aroma.

### SUMMARY

In view of the problems in the prior art, the present disclosure is intended to design and provide a technical solution of a method for liquid fermentation of black tea juice by using aged green tea.

The present disclosure is realized through the following technical solution:

A method for liquid fermentation of black tea juice by using aged green tea comprises the following process steps:

1) mixing aged green tea (green tea preserved for 3-5 years) with hot water for a water bath-assisted extraction to prepare a crude catechin extract;

2) adding a tannase into the crude catechin extract obtained in step 1) for a water bath-assisted enzymolysis to obtain a primarily enzymolyzed crude catechin extract;

3) freeze-withering fresh tea leaves;

4) homogenizing the freeze-withered leaves obtained in step 3);

5) pouring a homogenate obtained in step 4) into the primarily enzymolyzed crude catechin extract, adding a β-glucosidase for secondary enzymolysis and performing fermentation; and

6) treating a fermentation broth obtained in step 5) by microwave heating, and performing filtration and cooling to a room temperature to obtain black tea juice by liquid fermentation using aged tea.

Further, the hot water in step 1) has a temperature of 85° C. and the water bath-assisted extraction is conducted for 20 min at a tea-to-water ratio w/v of 1:50.

Further, in step 2), the tannase has an enzyme activity higher than 5,000 U/g and is added at an amount w/w of 0.2%.

Further, in step 2), the water bath-assisted enzymolysis is performed at 50° C. for 7.5 min.

Further, in step 3), during the freeze-withering, the fresh tea leaves picked in any season are frozen at a temperature of −20° C. to −80° C. for 2 h or more and thawed for 1 h.

Further, in step 4), the homogenizing is performed with a ratio of fresh leaves and water w/v at 1:50 and at a 2nd gear for 2 min with an interval of 5-10 s every 30 s.

Further, in step 5), the β-glucosidase has an enzyme activity higher than 100 U/g and is added at an amount w/v of 1:400.

Further, in step 5), the fermentation is performed to control a temperature of the fermentation broth to 35° C., with a defoaming agent at 0.2% of a volume of the fermentation broth and in a manner of uniform ventilation for 1 h with a ventilation capacity 150 times of the total volume of the fermentation broth.

Further, in step 6), the microwave heating is performed to 90° C.

A homogenizing treatment device used in the present disclosure is a Philips mixer HR2084.

The method for liquid fermentation of black tea juice by using aged green tea has a reasonable design. The aged green tea is used to prepare a crude catechin extract, direct crushing is not used, thus an influence of a leaf base of the aged tea is avoided and crude stale odor is reduced. A tannase is used to hydrolyze the crude catechin extract, thus ester catechins reduce and non-ester catechins increase, which is beneficial to formation of theaflavin. Compared with room-temperature withering, freeze-withering of fresh tea leaves can shorten withering time, increases an activity of a polyphenol oxidase, improves efficiency of liquid fermentation, reduces the addition amount of fresh leaves and thus reduces plant odor. The fresh tea leaves picked in any season can be frozen and stored, are ready to use, and can be used for production in four seasons without being affected by the season. Homogenizing is performed at a medium and low speed and at intervals, such that the activity of the polyphenol oxidase can be maintained. During ventilation fermentation, a production cost can be reduced by ventilating air instead of pure oxygen. A β-glucosidase is added to hydrolyze glycoside substances to release more floral and fruity compounds. Microwave heating is rapid and even. A traditional processing technology of black tea is combined with a liquid fermentation technology, two enzymes are used to further treat a fermentation process, stale odor of the aged tea can be reversed, remaining catechin is fully utilized, the content of floral and fruity components is significantly improved, the content of theaflavin in tea juice is improved, and the whole flavor quality of the aged tea is improved. After the black tea juice is diluted 5 times, the tea juice has a prominent delicate-flower tea aroma, is red and bright, and has a sweet and mellow taste.

### DESCRIPTION OF THE EMBODIMENTS

The present invention is further illustrated by the following description in conjunction with the embodiments.

### Example 1 Method for Liquid Fermentation of Black Tea Juice by Using Aged Green Tea

(1) fresh Longjing 43 tea leaves (autumn tea) with one bud and four leaves picked in mid-October were freeze-withered at a freezing temperature of −20° C. for 4 h and thawed for 1 h;

(2) 4 g of broken aged green tea (20-mesh) was put into a conical flask and 200 mL of 85° C. hot water was poured for extraction for 20 min to prepare a crude catechin extract;

(3) 8 mg (addition amount w/w of 0.2%) of a tannase at 5,000 U/g was added into the crude catechin extract obtained in step (2) for enzymalysis at 50° C. for 7.5 min to obtain an enzymolyzed crude catechin extract;

(4) 6 g of the freeze-withered leaves obtained in step (1) were homogenized with 300 mL of water at a 2nd gear for 30 s×4;

(5) a homogenate obtained in step (4) was poured into the enzymolyzed crude catechin extract, 1 g of a β-glucosidase (i.e. 0.25% (w/v)) was added at 35° C., a defoaming agent at 0.2% of a volume of a fermentation broth was added, and ventilation fermentation was performed at a ventilation rate of 1 L/min for 1 h; and

(6) a fermentation broth obtained in step (5) was heated by microwave to 90° C., the heated fermentation broth was filtered using a 500-mesh filter cloth, and the filtered fermentation broth was cooled to a room temperature to obtain black tea juice by liquid fermentation using aged tea.

TABLE 1
Assessment of black tea juice

| | Color | | Aroma | | Taste | |
|---|---|---|---|---|---|---|
| Tea sample | Comment | Score | Comment | Score | Comment | Score |
| (1) Aged tea | Yellow and | 7.6 | Mature and | 6.2 | Heavy | 4.2 |
| | bright | | stale odor | | bitter and | |
| | | | | | stale taste | |
| (2) Aged tea-tea juice | Reddish | 6.5 | Grass aroma | 6.0 | Moderately | 7.0 |
| subjected to liquid | brown and | | | | mellow and | |
| fermentation | turbid | | | | slightly | |
| | | | | | astringent | |
| (3) Aged tea + tannase | Moderately | 8.3 | Plant odor and | 7.8 | Moderately | 7.8 |
| treatment-tea juice | red and | | slightly stuffy | | sweet and | |
| subjected to liquid | bright | | and sweet odor | | mellow and | |
| fermentation | | | | | slightly | |
| | | | | | astringent | |
| (4) Aged tea + | Bright red | 8.8 | Sweet and | 8.2 | Moderately | 8.2 |
| tannase + β-glucosidase | | | delicate-flower | | sweet and | |
| treatment-tea juice | | | tea aroma with | | mellow and | |
| subjected to liquid | | | slight | | slightly | |
| fermentation | | | astringency | | astringent | |

### Example 2 Method for Liquid Fermentation of Black Tea Juice by Using Aged Green Tea

(1) fresh Longjing 43 tea leaves (Winter tea) with one bud and two leaves picked in mid-December were freeze-withered at a freezing temperature of −20° C. for 24 h and thawed for 1 h;

(2) 4 g of broken aged green tea (20-mesh) was put into a conical flask and 200 mL of 85° C. hot water was poured for extraction for 20 min to prepare a crude catechin extract;

(3) 8 mg (addition amount w/w of 0.2%) of a tannase at 5,000 U/g was added into the crude catechin extract obtained in step (2) for enzymalysis at 50° C. for 7.5 min to obtain an enzymolyzed crude catechin extract;

(4) 6 g of the freeze-withered leaves obtained in step (1) were homogenized with 300 mL of water at a 2nd gear for 30 s×4;

(5) a homogenate obtained in step (4) was poured into the enzymolyzed crude catechin extract, 1 g of a β-glucosidase (i.e. 0.25% (w/v)) was added at 35° C., a defoaming agent of 0.2% of a volume of a fermentation broth was added, and ventilation fermentation was performed at a ventilation rate of 1 L/min for 1 h; and

(6) a fermentation broth obtained in step (5) was heated by microwave to 90° C., the heated fermentation broth was filtered using a 500-mesh filter cloth, and the filtered fermentation broth was cooled to a room temperature to obtain black tea juice by liquid fermentation using aged tea.

TABLE 2
Assessment of black tea juice

| | Color | | Aroma | | Taste | |
|---|---|---|---|---|---|---|
| Tea sample | Comment | Score | Comment | Score | Comment | Score |
| (1) Aged tea | Yellow | 5.0 | Mature odor | 2.8 | Heavy | 4.2 |
| | and bright | | | | bitter and | |
| | | | | | stale taste | |
| (2) Aged tea-tea juice | Reddish | 4.0 | Tea aroma with | 5.2 | Moderately | 7.0 |
| subjected to liquid | brown and | | plant odor | | mellow and | |
| fermentation | slightly | | | | slightly | |
| | turbid | | | | astringent | |
| (3) Aged tea + tannase | Slightly | 7.5 | Delicate-flower | 7.2 | Moderately | 7.8 |
| treatment-tea juice | deep | | tea aroma | | sweet and | |
| subjected to liquid | reddish | | | | mellow and | |
| fermentation | | | | | slightly | |
| | | | | | astringent | |
| (4) Aged tea + | Red and | 8.4 | Delicate-flower | 8.0 | Moderately | 8.2 |
| tannase + β-glucosidase | bright | | tea aroma with | | sweet and | |
| treatment-tea juice | | | sweet aroma | | mellow and | |
| subjected to liquid | | | | | slightly | |
| fermentation | | | | | astringent | |

### Example 3 Method for Liquid Fermentation of Black Tea Juice by Using Aged Green Tea

(1) fresh Longjing 43 tea leaves (Winter tea) with one bud and two leaves picked in mid-December were freeze-withered at a freezing temperature of −20° C. for 4 h and thawed for 1 h;

(2) 4 g of low-grade green tea was put into a conical flask and 200 mL of 85° C. hot water was poured for extraction for 20 min to prepare a crude catechin extract;

(3) 8 mg (addition amount w/w of 0.2%) of a tannase at 5,000 U/g was added into the crude catechin extract obtained in step (2) for enzymalysis at 50° C. for 7.5 min to obtain an enzymolyzed crude catechin extract;

(4) 4 g of the freeze-withered leaves obtained in step (1) were homogenized with 200 mL of water at a 2nd gear for 30 s×4;

(5) a homogenate obtained in step (4) was poured into the enzymolyzed crude catechin extract, 1 g of a β-glucosidase (i.e. 0.25% (w/v)) was added at 35° C., a defoaming agent at 0.2% of a volume of a fermentation broth was added, and ventilation fermentation was performed at a ventilation rate of 1 L/min for 1 h; and

(6) a fermentation broth obtained in step (5) was heated by microwave to 90° C., the heated fermentation broth was filtered using a 500-mesh filter cloth, and the filtered fermentation broth was cooled to a room temperature to obtain black tea juice by liquid fermentation using aged tea.

TABLE 3
Assessment of black tea juice

| | Color | | Aroma | | Taste | |
|---|---|---|---|---|---|---|
| Tea sample | Comment | Score | Comment | Score | Comment | Score |
| (1) Aged tea | Yellow and | 7.6 | Mature and | 6.2 | Heavy | 4.2 |
| | bright | | stale odor | | bitter and | |
| | | | | | stale taste | |
| (2) Aged tea-tea juice | Reddish | 6.5 | Grass aroma | 6.0 | Moderately | 7.0 |
| subjected to liquid | brown and | | | | mellow and | |
| fermentation | turbid | | | | slightly | |
| | | | | | astringent | |
| (3) Aged tea + tannase | Moderately | 8.3 | Plant odor and | 7.8 | Moderately | 7.8 |
| treatment-tea juice | red and | | slightly stuffy | | sweet and | |
| subjected to liquid | bright | | and sweet odor | | mellow and | |
| fermentation | | | | | slightly | |
| | | | | | astringent | |
| (4) Aged tea + | Bright red | 8.8 | Sweet and | 8.2 | Moderately | 8.2 |
| tannase + β-glucosidase | | | delicate-flower | | sweet and | |
| treatment-tea juice | | | tea aroma with | | mellow and | |
| subjected to liquid | | | slight | | slightly | |
| fermentation | | | astringency | | astringent | |

TABLE 4
Detection of theaflavins in black tea juice (GB/T 30483-2013)

| | Theaflavin (TF) content (μg/mL) | |
|---|---|---|
| Tea sample | TF | TFs (total content) |
| (1) Aged tea | — | — |
| (2) Aged tea-tea juice subjected | 21.326 ± 0.074^{b} | 61.373 ± 4.185^{c} |
| to liquid fermentation | | |
| (3) Aged tea + tannase | 193.846 ± 0.514^{a} | 258.757 ± 0.429^{a} |
| treatment-tea juice subjected to | | |
| liquid fermentation | | |
| (4) Aged | 191.906 ± 0.906^{b} | 237.378 ± 0.340^{b} |
| tea + tannase + β-glucosidase | | |
| treatment-tea juice subjected to | | |
| liquid fermentation | | |

Note: it should be noted that compared with tea sample (3), the β-glucosidase (lower activity with an addition amount of 1 g) in the “3-glucosidase treatment” in tea sample (4) would complex with theaflavins (TFs), thus the total content of TFs was decreased, a certain amount of the TFs was lost, but the tea has better color, aroma and taste (Table 3).

TABLE 5
Odor activity value (OAV) analysis of aroma components in black tea juice
(OAV = compound concentration/threshold and OAV > 1 means the compound can be smelled)

| | Threshold | OAV | | | |
|---|---|---|---|---|---|
| Compound | (μg/L) | (1) | (2) | (3) | (4) |
| Hexanal | 4.5 | 0.16 ± 0.03^{c} | 0.34 ± 0.02^{bc} | 0.38 ± 0.04^{b} | 1.09 ± 0.08^{a} |
| (E)-2-hexenal | 17 | 0.02 ± 0.01^{c} | 0.06 ± 0.02^{bc} | 0.08 ± 0.01^{b} | 0.12 ± 0.01^{a} |
| (E)-3-hexen-l-ol | 110 | 0.00 ± 0.00^{b} | 0.22 ± 0.05^{a} | 0.19 ± 0.02^{a} | 0.26 ± 0.00^{a} |
| n-hexanol | 5.6 | 0.08 ± 0.01^{b} | 2.04 ± 0.42^{a} | 1.94 ± 0.16^{a} | 2.40 ± 0.03^{a} |
| Methyl salicylate | 40 | 0.03 ± 0.01^{c} | 0.49 ± 0.08^{a} | 0.39 ± 0.02^{ab} | 0.36 ± 0.01^{b} |
| Benzaldehyde | 350 | 0.01 ± 0.00^{b} | 0.01 ± 0.00^{b} | 0.01 ± 0.00^{b} | 0.02 ± 0.00^{a} |
| D-limonene | 34 | 0.01 ± 0.00^{b} | 0.18 ± 0.03^{a} | 0.16 ± 0.00^{a} | 0.17 ± 0.00^{a} |
| Benzyl alcohol | 20000 | 0.00 ± 0.00 | 0.00 ± 0.00 | 0.00 ± 0.00 | 0.00 ± 0.00 |
| Citral | 53 | 0.01 ± 0.01^{b} | 5.04 ± 0.81^{a} | 4.16 ± 0.18^{a} | 4.44 ± 0.26^{a} |
| Phenylacetaldehyde | 4 | 0.59 ± 0.03^{a} | 0.60 ± 0.15^{a} | 0.51 ± 0.12^{a} | 0.52 ± 0.10^{a} |
| Linalool oxide II | 190 | 0.00 ± 0.00^{b} | 0.05 ± 0.01^{a} | 0.04 ± 0.01a | 0.04 ± 0.00^{a} |
| Linalool | 0.22 | 10.53 ± 2.29^{b} | 339.91 ± 69.34^{a} | 264.91 ± 17.51^{a} | 259.79 ± 2.24^{a} |
| Nonaldehyde | 1.1 | 1.95 ± 0.02^{a} | 2.42 ± 0.76^{a} | 2.06 ± 0.25^{a} | 1.81 ± 0.06^{a} |
| Phenethyl alcohol | 390 | 0.00 ± 0.00^{b} | 0.02 ± 0.00^{a} | 0.02 ± 0.00^{a} | 0.03 ± 0.01^{a} |
| Nerol | 49 | 0.03 ± 0.00^{c} | 0.11 ± 0.01^{a} | 0.09 ± 0.01^{ab} | 0.09 ± 0.00^{b} |
| Geraniol | 7.5 | 0.65 ± 0.06^{b} | 35.64 ± 5.77^{a} | 29.54 ± 1.16^{a} | 31.46 ± 1.70^{a} |

In the example, tea sample (2) was treated without adding the tannase and the β-glucosidase, and other conditions were the same as those in the example; and tea sample (3) was treated only with the tannase, and other conditions were the same as those in the example.

To sum up, the method for preparing liquid-fermented black tea juice by using aged tea provided by the present disclosure uses endogenous enzymes (mainly polyphenol oxidase and peroxidase) of fresh tea leaves (picked in any season) and exogenous enzymes (tannase and β-glucosidase) to catalyze conversion of the aged tea catechin extract, promotes conversion of catechins in aged tea to theaflavins (increased by nearly 3 times, see Table 4-(4)), promotes hydrolysis of glycosides to release bound aroma (OAVs of two characteristic aroma compounds of black tea, linalool and geraniol, are significantly increased, see Table 5-(4)), successfully removes stale odor of aged tea, and enables the black tea juice to have a main sweet aroma and a slight floral aroma, a red and bright color and a sweet and mellow taste. The method solves a problem of a large inventory of aged tea, further promotes high-value utilization of summer and autumn tea, and has a low cost and high economic benefits.

What is claimed is:

1. A method for liquid fermentation of black tea juice by using aged green tea, comprising the following process steps:
1) mixing aged green tea with hot water for a water bath-assisted extraction to prepare a crude catechin extract;
2) adding a tannase into the crude catechin extract obtained in step 1) for a water bath-assisted enzymolysis to obtain a primarily enzymolyzed crude catechin extract;
3) freeze-withering fresh tea leaves;
4) homogenizing the freeze-withered leaves obtained in step 3);
5) pouring a homogenate obtained in step 4) into the primarily enzymolyzed crude catechin extract, adding a β-glucosidase for secondary enzymolysis and performing fermentation; and
6) treating a fermentation broth obtained in step 5) by microwave heating, and performing filtration and cooling to a room temperature to obtain black tea juice by liquid fermentation using aged tea.

2. The method for liquid fermentation of black tea juice by using aged green tea according to claim 1, wherein the hot water in step 1) has a temperature of 85° C. and the water bath-assisted extraction is conducted for 20 min at a tea-to-water ratio w/v of 1:50.

3. The method for liquid fermentation of black tea juice by using aged green tea according to claim 1, wherein in step 2), the tannase has an enzyme activity higher than 5,000 U/g and is added at an amount w/w of 0.2%.

4. The method for liquid fermentation of black tea juice by using aged green tea according to claim 1, wherein in step 2), the water bath-assisted enzymolysis is performed at 50° C. for 7.5 min.

5. The method for liquid fermentation of black tea juice by using aged green tea according to claim 1, wherein in step 3), during the freeze-withering, the fresh tea leaves picked in any season are frozen at a temperature of −20° C. to −80° C. for 2 h or more and thawed for 1 h.

6. The method for liquid fermentation of black tea juice by using aged green tea according to claim 1, wherein in step 4), the homogenizing is performed with a ratio of fresh leaves and water w/v at 1:50 and at a 2nd gear for 2 min with an interval of 5-10 s every 30 s.

7. The method for liquid fermentation of black tea juice by using aged green tea according to claim 1, wherein in step 5), the β-glucosidase has an enzyme activity higher than 100 U/g and is added at an amount w/v of 1:400.

8. The method for liquid fermentation of black tea juice by using aged green tea according to claim 1, wherein in step 5), the fermentation is performed to control a temperature of the fermentation broth to 35° C., with a defoaming agent at 0.2% of a volume of the fermentation broth and in a manner of uniform ventilation for 1 h with a ventilation capacity 150 times of a total volume of the fermentation broth.

9. The method for liquid fermentation of black tea juice by using aged green tea according to claim 1, wherein in step 6), the microwave heating is performed to 90° C.
